(19) United States
(12) Patent Application Publication
(10) Pub. No.: US 2009/0325803 A1
(43) Pub. Date: Dec. 31, 2009

(54) CONTROL OF AQUATIC WEEDS USING SELECTED HERBICIDAL COMBINATIONS WITH A SYNTHETIC AUXIN

(76) Inventor: Tyler J. Koschnick, Medina, OH (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/429,441

(22) Filed: Apr. 24, 2009

Related U.S. Application Data
(60) Provisional application No. 61/048,054, filed on Apr. 25, 2008.

(51) Int. Cl. A01N 43/60; A01N 43/40; A01P 13/02; B65D 21/02

(52) U.S. Cl. 504/136; 504/130; 220/23.83

(57) ABSTRACT

Described are preferred methods and compositions for controlling aquatic weeds that involve the use of an herbicidal combination including a first herbicidal agent selected from triclopyr and 2,4-d and at least a second selected herbicidal agent. In preferred methods of the invention, the selected second herbicidal agent can be fluridone, diquat, an ALS inhibitor, or 2,4-d, with the proviso that when the second herbicidal agent is 2,4-d the first herbicidal agent is triclopyr. Preferred herbicidal combinations allow for enhanced control and/or selectivity when treating a body of water to control a target weed population, such as a watermilfoil, curlyleaf pondweed, Brazilian elodea, and/or hydrilla weed population.

### REFERENCE TO RELATED APPLICATION

The present application claims the benefit of U.S. Provisional Patent Application No. 61/048,054 filed Apr. 25, 2008, entitled CONTROL OF AQUATIC WEEDS USING SELECTED HERBICIDAL COMBINATION WITH A SYNTHETIC AUXIN, which is hereby incorporated herein by reference in its entirety.

### BACKGROUND

The present invention related generally to methods and compositions for controlling aquatic weeds, and in certain embodiments to methods and compositions for controlling aquatic weeds utilizing herbicidal combinations that include a synthetic auxin in combination with at least one additional herbicidal agent.

As further background, aquatic plants very commonly arise as undesired weeds in waters and wetlands in the United States of America and elsewhere. Three such exotic weeds are hydrilla, curlyleaf pondweed, and watermilfoil, including Eurasian watermilfoil, which present problems in ponds, lakes, and other water bodies. The treatment of such bodies of water to eliminate or control the undesired or exotic aquatic weeds is often complicated by the fact that the agent used to control the undesired weed also detrimentally effects the health of other, desirable or native plant life within the water body. Thus, treatment regimens that are more selective for the undesired or exotic plant species are needed.

The efficacy of herbicidal agents against the target aquatic weeds depends on several factors, including the application dose, the specific formulation, the plant type, climatic conditions, water and sediment conditions in the water body, herbicide exposure time, and the like. Aquatic weeds such as submersed weeds present a special case for control, different from terrestrial plants. Generally, there is no cuticle to penetrate, plants have reduced vascular systems, effective doses are much lower, the leaves are only a couple of cells thick, and herbicidal agents are diluted in the aqueous environment of which the plant grows vs. directly deposited on the plant surface. For these and other reasons, it is commonly found that compounds that are active on terrestrial plants have little efficacy on submersed plants.

At times, an inability to control an undesired aquatic weed can be eliminated simply by increasing the dose for a particular herbicidal agent. However, this is not always the case, and higher doses can exacerbate undesired affects on beneficial plants.

One possible way to improve aquatic weed control is to combine two or more active compounds in the treatment. However, the use of two or more active compounds often fails due to physical or biological incompatibility, lack of stability in co-formulation, decomposition of the compounds, antagonistic effects between the compounds, and/or other factors.

In view of the background in aquatic weed control, the discovery of enhanced or alternative methods and compositions for the control of aquatic weeds has been a difficult endeavor. Serious needs thus remain.

### SUMMARY

In certain aspects, it has been discovered that aquatic weeds such as watermilfoil can be effectively controlled by combinations of a first herbicidal agent selected from triclopyr and 2,4-d with at least a second selected herbicidal agent. Preferred embodiments of the invention involve methods for controlling aquatic weeds with a first herbicidal agent selected from triclopyr and 2,4-d and at least a second herbicidal agent selected from a carotenoid biosynthesis inhibitor such as fluridone, an ALS inhibitor such as penoxsulam, a photosynthetic inhibitor such as diquat, or a synthetic auxin herbicide agent such as 2,4-d, with the proviso that when the second herbicidal agent is 2,4-d or a similar synthetic auxin, the first herbicidal agent is triclopyr. Combinations of synthetic auxins, such as 2,4-d combined with triclopyr, can be used in combinations also containing one or more of the other types of named herbicidal agents disclosed herein. Aspects of the present invention therefore relate to methods for treating water bodies to control undesired aquatic weeds with combinations of these active agents, to compositions including such combinations, and to methods for preparing herbicidal combination compositions which involve mixing such combinations of active agents. Still further inventive embodiments, as well as features and advantages thereof, will be apparent from the descriptions herein.

### BRIEF DESCRIPTION OF THE DRAWINGS

FIG. 1.1. Eurasian watermilfoil control following treatment of fluridone at 6 ppb plus triclopyr at 30 ppb (FLURIDONE+TRICLOPYR) compared to untreated controls (n=3±S.E.).

FIG. 2.1. Root and shoot dry weights of Eurasian watermilfoil following a 40 d exposure to 75 ppb triclopyr (T) or 10 ppb fluridone (F) alone, and in combination at a total of 85 ppb (F 10 ppb+T 75 ppb; 1:7.5 ratio) (n=3±S.E.).

FIG. 3.1. Root and shoot dry weights of EWM following treatment with triclopyr (TR1), 2,4-d, or diquat (DQ) alone at 50 ppb, and in combination at 50 ppb each (total 100 ppb; 1:1 ratio) (n=3±S.E.).

FIG. 4.1. Response (biomass) of Eurasian watermilfoil to triclopyr and 2,4-d applied alone and in combination at various ratios (n=3). The horizontal dotted line represents the mean dry weight of plants at the time of treatment.

FIG. 4.2. Isobole analysis of triclopyr and 2,4-d mixtures on Eurasian watermilfoil (n=3). The “independent action” line defines the amount of each herbicide necessary to cause a 50% reduction in biomass assuming there is no antagonism/synergism. It was calculated based on the dose of triclopyr or 2,4-d each necessary to cause a 50% effect when applied alone. The action of the 2 herbicides in combination is synergistic if the mixture line falls below the independent action line. The action of the 2 herbicides is antagonistic if the mixture line is above the independent action line. When the mixture line falls between the upper and lower confidence intervals, this is indicative of an independent herbicidal response.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

As discussed above, aspects of the present invention relates to methods and compositions involving the use of a first herbicidal agent selected from triclopyr or 2,4-d in combination with a second selected herbicidal agent. Preferred embodiments of the invention involve methods and compositions wherein triclopyr or 2,4-d is used in combination with at least a second agent selected from fluridone, diquat, an ALS inhibitor, or 2,4-d, with the proviso that when the second agent is 2,4-d the first agent is triclopyr. Combinations of synthetic auxins, such as 2,4-d combined with triclopyr, can be also used in combinations with one or more of the other types of named herbicidal agents disclosed herein.

Herbicidal combinations of the invention desirably: enable the use of lower levels of each herbicidal agent as compared to that which would have to be used with each agent individually; enable the use of sub-lethal levels of each herbicidal agent (if used individually); enable a reduction in the total amount of herbicide needed for control (reducing water use restriction); enable a reduction in the total exposure time needed for control; exhibit an activity that is greater than the individual agents when used alone, more desirably a synergistic or at least additive effect; enhance the level of control for the target aquatic weed population; increase the spectrum of activity possible with either agent alone; and/or enhance the selectivity for the target aquatic weed population. As well, the use of such herbicidal agent combinations may enhance the treatment of aquatic weed biotypes that have developed resistance to at least one of the agents included, and may benefit long term weed control by inhibiting the development of additional resistant biotypes. Using tank mixes of herbicidal agents or otherwise applying herbicides with multiple modes of action is a means of proactive resistance management. The use of multiple agents in combination presents less chance for selecting a biotype that is resistant under simultaneous exposure, as the biotype would have to confer resistance to all agents used.

The combination of agents used in certain aspects of the invention will include at least one auxinic herbicidal agent, especially triclopyr (3,5,6-trichloro-2-pyridyloxyacetic acid) or herbicidally active salts or esters thereof, including a triethylamine salt or butoxyethyl ester or 2,4-d ((2,4-dichlorophenoxy) acetic acid or herbicidally active salts or esters thereof, including a dimethylamine salt, sodium salt or butoxyethyl ester. In this regard, it will be understood that herbicidal compounds such as those identified herein by common name are often available as a parent compound or as an herbicidally active derivative such as a salt or ester. Accordingly, all such herbicidally active derivatives are intended to be encompassed by use of the common name for the herbicidal compound, unless otherwise specified.

The chemical fluridone (1-methyl-3-phenyl-5-3-(trifluoromethyl)phenyl-4(1H)-pyridinone) is a known herbicide for use in the control of aquatic weeds. Fluridone is sold under the trade name SONAR®, available from SePRO Corporation, Carmel, Ind., in either liquid or pelleted (on clay) formulations. Fluridone is a systemic herbicide that is absorbed from water by plant shoots and from hydrosoil by roots. It inhibits carotenoid synthesis which in turn enhances the degradation of chlorophyll. This produces a characteristic bleached appearance to susceptible plants.

Acetolactate synthase (ALS) or acetohydroxy acid synthase (AHAS) inhibitors represent another class of herbicidal agents. These agents inhibit the acetolactate synthase enzyme, which leads to the depletion of key amino acids that are necessary for protein synthesis and plant growth. The following herbicidal agents belong to this class and are preferred for use in the invention:

| Generic | |
|---|---|
| Name | Chemical Name |
| Penoxsulam | 2-(2,2-difluoroethoxy)-6-trifluoromethyl-N-(5,8- |
| | dimethoxy[1,2,4]triazolo[1,5c]pyrimidin-2- |
| | yl)benzenesulfonamide) |
| Bensulfuron- | 2-((((((4,6-Dimethoxy-2- |
| methyl | pyrimidinyl)amino)carbonyl)amino)sulfonyl)methyl)benzoic |
| | acid, ethyl ester |
| Bispyribac- | Benzoic acid, 2,6-bisõ(4,6-dimethoxy-2-pyrimidinyl)oxy- |
| sodium | sodium salt |
| Imazamox | 2-[4,5-dihydro-4-methyl-4-(1-methylethyl)-5-oxo-1H- |
| | imidazol-2-yl]-5-(methoxymethyl)-3-pyridinecarboxylic |
| | acid |

The photosynthetic inhibitor diquat (1,1′-ethylene 2,2′-dipyridylium dibromide) is a contact herbicide. Contact of foliage with diquat results in rapid disruption of cell membranes and a rapid kill. Diquat penetrates into the cytoplasm and causes the formation of peroxides and free electrons which destroy the cell membranes almost immediately.

In accordance with certain embodiments of the invention, methods for the control of aquatic weeds include the application of a combination of herbicides as disclosed above. As to amounts, these agents will be included in a combination that is effective to achieve control of the aquatic weed(s) in question. In certain forms of the invention, such amounts will be in the range of about 1 to about 4000 parts per billon (ppb), more typically in the range of about 2 to about 2000 ppb, more specifically 4 to 1000 ppb, for each of the active agents included in the combination, although other amounts may be used in broader aspects of the invention. It has been discovered that such herbicidal combinations can be used together without having the herbicidal agents antagonize one another.

In embodiments in which triclopyr is used in combination with fluridone, the triclopyr can be used at a level in the range of about 50 to about 2000 ppb, and will more desirably be used at a level in the range of 50 to 500 ppb, and the fluridone at a level in the range of about 2 to about 150 ppb, more desirably about 2 to about 10 ppb. As well, in these or other embodiments, the triclopyr and fluridone will desirably be used in a respective mass ratio of about 10:1 to about 125:1.

In embodiments in which triclopyr is used in combination with an ALS inhibitor, the triclopyr can be used at a level in the range of about 50 to about 2000 ppb, and will more desirably be used at a level in the range of 50 to 500 ppb, and the ALS inhibitor at a level in the range of about 2 to about 200 ppb, more desirably about 2 to about 100 ppb. In such embodiments, the ALS inhibitor can be selected from penoxsulam, bensulfiron-methyl, bispyribac-sodium, and imazamox. As well, in these or other embodiments, the triclopyr and ALS inhibitor will desirably be used in a respective mass ratio of about 1:1 to about 125:1.

In embodiments in which triclopyr is used in combination with diquat (photosynthetic inhibitor), the triclopyr will desirably be used at a level in the range of 100 to 2500 ppb and the diquat at a level in the range of about 50 to about 370 ppb. As well, in these or other embodiments, the triclopyr and diquat will desirably be used in a respective mass ratio of about 50:1 to about 1:1.

In embodiments in which triclopyr is used in combination with 2,4-d, the triclopyr will desirably be used at a level in the range of 20 to 2000 ppb and the 2,4-d at a level in the range of about 80 to about 4000 ppb, more desirably about 80 to about 3600 ppb. As well, in these or other embodiments, the triclopyr and 2,4-d will desirably be used in a respective mass ratio of about 1:1 to about 1:9, with a more preferred ratio of 1:4 to 3:7.

In embodiments in which 2,4-d is used in combination with fluridone, the 2,4-d can be used at a level in the range of about 100 to about 4000 ppb, and will more desirably be used at a level in the range of 100 to 1000 ppb, and the fluridone at a level in the range of about 2 to about 150 ppb, more preferably about 2 to about 10 ppb. As well, in these or other embodiments, the 2,4-d and fluridone will desirably be used in a respective mass ratio of about 20:1 to about 250:1.

In embodiments in which 2,4-d is used in combination with an ALS inhibitor, the 2,4-d can be used at a level in the range of about 100 to about 4000 ppb, and will more desirably be used at a level in the range of 100 to 1000 ppb and the ALS inhibitor at a level in the range of about 2 to about 200 ppb, more preferably at a level in the range of about 2 to about 100 ppb. In such embodiments, the ALS inhibitor can be selected from penoxsulam, bensulfaron-ethyl, bispyribac-sodium, and imozamax. As well, in these or other embodiments, the 2,4-d and ALS inhibitor will desirably be used in a respective mass ratio of about 1:1 to about 250:1.

In embodiments in which 2,4-d is used in combination with diquat (photosynthetic inhibitor), the 2,4-d will desirably be used at a level in the range of 200 to 4000 ppb and the diquat at a level in the range of about 50 to about 370 ppb. As well, in these or other embodiments, the 2,4-d and diquat will desirably be used in a respective mass ratio of about 80:1 to about 1:1.

With respect to the above-identified levels and mass ratios of 2,4-d, triclopyr, and other herbicidal agents, it will be understood that not all aspects of the invention are limited to the stated levels or ratios, and that different amounts or ratios may be used in other embodiments, depending upon the plant management objectives, the target species, expected exposure time, intended use pattern, formulation, or other factors. Sequential applications or bump treatments, or application with controlled release formulations may be conducted to maintain exposure with the target plants and increase levels cumulatively of either agent in the combination.

In additional embodiments of the invention, other herbicidal agents may be used in combinations comprising 2,4-d or triclopyr. The other agent may be a “PPO inhibitor”, which inhibits the protoporphyrinogen oxidase enzyme in the chlorophyll biosynthesis pathway, ultimately resulting in cell membrane leakage. The PPO inhibitor can be carfentrazone-ethyl (ethyl α,2-dichloro-5-[4-(difluoromethyl)-4,5-dihydro-3-methyl-5-oxo-1H-1,2,4-triazol-1-yl]-4-fluorobenzenepropanoate) or flumioxazin (2-[7-fluoro-3,4-diliydro-3-oxo-4-(2-propynyl)-2H-1,4-benzoxazin-6-yl]-4,5,6,7-tetrahydro-1H-isoindole-1,3(2H)-dione). In certain aspects, such PPO inhibitors can be used in the combination at a level of about 50 ppb to about 200 ppb. The other agent may be a carotenoid biosynthesis inhibitor (CBI) such as mesotrione (2-[4-(methysulfonyl)-2-nitrobenzoyl]-1,3-cyclohexanedione) or topramzeone ([3-(4,5-dihydro-3-isoxazolyl)-2-methyl-4-(methylsulfonyl)phenyl](5-hydroxy-1-methyl-1H-pyrazol-4-yl)methanone). In certain aspects, such CBI agents can be used at a level of about 5 ppb to about 200 ppb. The other agent may be a membrane disrupting herbicide, which are known to effect cell integrity and uncouples membrane transport mechanisms resulting in cell degradation. Copper is an example of a membrane disrupter. In certain aspects, the membrane disrupting herbicide can be used in the combination at a level of about 100 ppb to about 500 ppb. In still further embodiments, the quinoline carboxylic acid, quinclorac (3,7-dichloro-8-quinolinecarboxylic acid), the pyridine carboxylic acid, aminopyralid (4-amino-3,6-dichloro-2-pyridinecarboxylic acid), or the pyridinoxy acid, fluoroxypyr ([(4-amino-3,5-dichloro-6-fluoro-pyridinyl)oxy]acetic acid), which are alternative synthetic auxin type herbicidal agents to triclopyr and 2,4-d, can be used in combinations also containing one or more of the other types or named herbicidal agents disclosed herein. In certain aspects, such alternative synthetic auxins can be used in the combinations at a level in the range of about 50 ppb to about 0.5 ppm. Combinations of synthetic auxins, such as 2,4-d+triclopyr, can be used in combinations also containing one or more of the other types of named herbicidal agents disclosed herein, including the membrane disrupting herbicide endothall. In this respect, endothall can generally be used at a level in the range of 250 to 2000 ppb a.e., and the synthetic auxins, such as 2,4-d and triclopyr, can be used at their respective usage levels, and in the manners, disclosed herein.

Methods and compositions of the invention may be used in the complete or partial control of many noxious plants. These include, for example, common duckweed (Lemna minor), of the emersed plants spatterdock (Nuphar luteum) and water-lily (Nymphaea spp.), of the submersed plants bladderwart (Utricularia spp.), common coontail (Ceratophyllum demersum), common elodea (Elodea canadensis), Brazilian elodea (Egeria densa) fanwort (Cabomba caroliniana), hydrilla (Hydrilla verticillata), naiad (Najas spp.), pondweed (Potamogeton spp.) and more specifically curlyleaf pondweed (Potamogeton crispus), watermilfoil (Myriophyllum spp.) including Eurasian watermilfoil, floating plants including common watermeal (Wolffia columbiana) and salvinia (Salvinia spp.), emersed plants including alligatorweed (Alternanthera philoxeroides), American lotus (Nelumbo lutea), creeping waterprimrose (Ludwigia peploides), parrotfeather (Myriophyllum aquaticum), smartweed (Polygonaum spp.), spikerush (Eleocharis spp.), waterpurslane (Ludwigia palustris), and watershield (Brasenia schreberi), of the submersed plants Illinois pondweed (Potamogeton illinoensis), linmophila (Limnophila sessilifora), tapegrass or American eelgrass (Vallisneria americana), and variable leaf watermilfoil (Myriophyllum heterophyllum), and the shoreline grasses barnyardgrass (Echinochloa crusgalli), and southern watergrass (Hydrochloa caroliniensis). Particularly preferred plant types for control in accordance with the invention include hydrilla, curlyleaf pondweed, Brazilian elodea, and/or watermilfoil. In treatments in accordance with some aspects of the invention, combining the herbicidal agents may control multiple species simultaneously while using lower concentrations of each agent.

For use together, it is not necessary that the two or more herbicides be applied in a physically combined form, or even at the same time. The combination effect results so long as the two or more herbicides are present in the body of water at the same time, regardless of when they were applied. Thus, for instance a physical combination of the two or more herbicides could be applied, or one or some could be applied earlier than the other(s). Typically, however, the herbicides will be applied within 1 to 7 days of each other. Further, in certain embodiments the herbicides can be applied within about 90 days or less of each other, or within about 30 days or less of each other, in which case the herbicides may or may not be present in the body of water at the same time. For example, one agent can be applied in the presence of or following an exposure to the other agent, for example to reduce exposure time, inhibit potential for plant recovery, or enhance efficacy or selectivity. Thus, one herbicidal agent may or may not be present for the duration based on chemical half-lives in water or can be added to the other agent or after the other agent was in the presence of the target plant or vice versa. In preferred forms in which the herbicides are not present in the body of water at the same time, the second or following sequentially applied herbicide will nonetheless be applied at a time at which the target plants are still exhibiting an effect from the prior-applied herbicide, in which cases the prior herbicide may have been applied at lethal, or at sub-lethal doses. Symptoms of such continuing stress from the prior applied herbicide will depend upon the particular plant species and/or particular herbicide involved and will be determinable by those skilled in the field, but may for example include a reduced biomass or deterioration in health of the target plants as compared to the time at which the prior-applied herbicide was introduced into the body of water.

Any of the herbicides can thus be applied separately in liquid or solid form, or a combination product containing some or all herbicides could be produced, again, in either liquid or solid form. Typical liquid formulations include emulsions, suspensions (including suspensions containing microcapsules), solutions, emulsifiable concentrates, and flowables. Common solid forms include granules, wettable powders, water-dispersible solid (including water-dispersible granules containing microencapsulated pesticides) or dusts. The herbicidal formulation can also contain, in addition to the active herbicide(s) other ingredients such as solvents, wetting agents, suspending agents, anti-caking agents, dispersing agents, emulsifiers, antifreeze agents, antifoam agents, and other additives.

Compositions according to this invention may contain the two or more herbicides in numerous different physical forms. In some cases, a composition may be produced by simply physically mixing (“tank mixing”) commercially available products containing the active herbicides. Alternatively, a package may be manufactured and sold which contains the two or more herbicides in separate containers, but packaged together, e.g. in a “multi-pack” format such as a “twin-pack” or “tri-pack”.

Alternatively, previously prepared compositions (“premixes”) containing the two or more herbicides can be produced. Suitable liquid compositions would include solutions or emulsions containing the two or more herbicides. A solid product containing the two or more herbicides could also be produced, for instance, as impregnated granules.

The combination of herbicidal agents utilized should remain at herbicidally effective levels in the body of water in contact with the targeted plant to achieve control. Thus, in accordance with preferred methods of the invention, herbicidal agent levels will be maintained in the treatment area or the body of water under treatment sufficient periods to control target plants. This period will range from a day or less to several weeks although one herbicidal agent may be present for a longer period of time than the other based, for example, on chemical half-lives in water.

Bodies of water to be treated with the inventive methods will typically be fresh water bodies such as ponds, lakes, wet lands, reservoirs, rivers or irrigation canals, although other bodies of water may also be treated in accordance with the invention.

In order to promote a further understanding of the present invention and its various embodiments, the following specific examples are provided. It will be understood that these examples are illustrative and not limiting of the invention.

### Example 1

### Control of Eurasian Watermilfoil with Fluridone and Triclopyr

### Materials and Methods

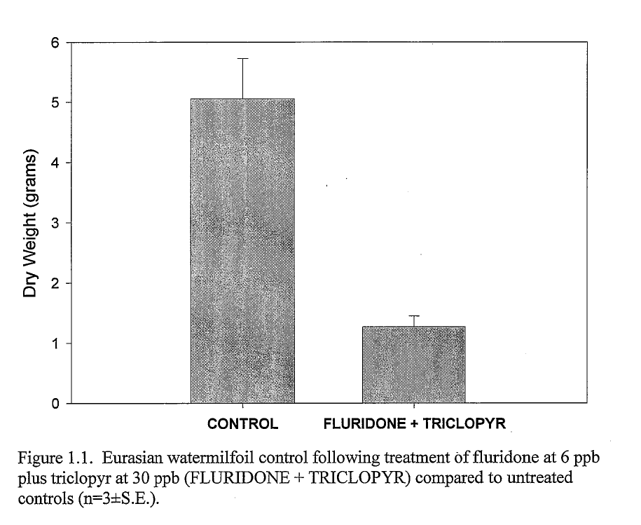

Four apical sections (12 to 15 cm in length) of Eurasian watermilfoil (EWM) were planted into four inch square pots containing Wallace Farm® topsoil amended with 14-14-14 slow release Osmocote® fertilizer (˜2.5 g Osmocote/kg soil). Approximately 5 to 7 cm of the apical section extended above the sediment at planting, and a sand cap was placed over the potting soil (˜2 cm deep). Six 10.2 cm square pots were placed into each 200 L tall black tub filled with well water in a shadehouse. Plants were allowed to grow to two-thirds the height of tanks before the following treatments were initiated in triple replicate: 1) fluridone (6 ppb)+triclopyr (30 ppb), 2) untreated controls. Plants were harvested at 70 d and dry weights were determined (FIG. 1.1).

### Results

The results of this experimental are summarized in FIG. 1.1. As shown, the triclopyr/fluridone combination proved to be compatible and demonstrated about 75% control of the watermilfoil. Thus, in this study, a combination of 30 ppb triclopyr plus a single application of 6 ppb fluridone was effective in controlling milfoil.

### Example 2

### Control of Eurasian Watermilfoil with Trielopyr and Fluridone

### Materials and Methods

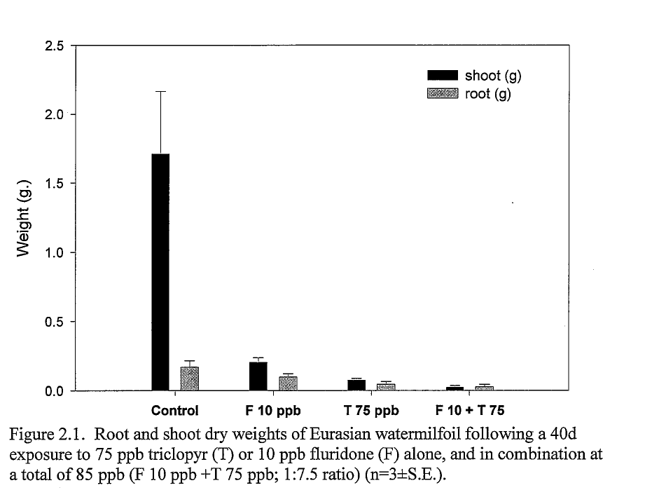

Apical sections (12 to 15 cm in length) of Eurasian watennilfoil (EWM) were planted into small pots (13.5 cm length×3.75 cm diameter) containing Wallace Farm® topsoil amended with 14-14-14 slow release Osmocote® fertilizer (˜2.5 g Osmocote/kg soil). Approximately 5 to 7 cm of the apical section extended above the sediment at planting, and a sand cap was placed over the potting soil (˜2 cm deep). Plants were then transferred to a 12 L acrylic tanks filled with well water. Plants were allowed to grow for 7 d before the following treatments were initiated in triple replicate: 1) fluridone at 10 ppb, 2) triclopyr at 75 ppb, 3) fluridone (10 ppb) plus triclopyr (75 ppb), 4) untreated controls. Plants were harvested at 40 d. At harvest, plants were rinsed free of algae, roots and shoots were separated, and placed in paper sacks in a drying oven for 4 d at 70° C. temperature, and dry weights were determined (FIG. 2.1).

### Results

The results of this experimental are summarized in FIG. 2.1. As shown, the triclopyr/fluridone combination proved to be compatible and demonstrated very effective control of the watermilfoil. Root and shoot biomass was separated to evaluate a plants ability to recover or regrow from root stock following herbicide exposure. Triclopyr (75 ppb) reduced above ground biomass by 96%, but had less effect on below ground biomass (74% reduction) leaving a source of potential regrowth. Triclopyr (75 ppb) in combination with fluridone (10 ppb) increased root control to 84% (total biomass reduction of 97.3%). Therefore, the combination unexpectedly provided greater efficacy on total biomass, and more importantly, the below ground biomass; thus limiting tissue for potential regrowth. It was not anticipated that a combination of fluridone and triclopyr would increase efficacy, but it increased compared to either herbicide alone in this study. There was potential for antagonism between these herbicides: triclopyr is a relatively rapid acting herbicide (<4 day exposure), and fluridone is a relatively slow-acting herbicide (>45 day exposures). Although stimulatory in nature short-term, sub-lethal triclopyr concentrations could limit biomass for long-term fluridone uptake and injured plants may take up less herbicide due to reduced growth. Therefore, combined they could antagonize the activity of the other, but this was not observed in this trial and is likely dependent on dose. If triclopyr concentrations are too great, it could pretense or antagonize the effects of fluridone. Triclopyr and fluridone were more effective in combination and at lower use rates than typically used for submersed weed control.

Results from Example 1 and Example 2 suggest that triclopyr at low concentrations may be effective in combination with fluridone by reducing exposure requirements of fluridone. Short-term, triclopyr stimulates plants to elongate which may deplete some carbohydrate storage, which effectively could reduce the time required to starve the plant with fluridone sequentially or simultaneously with triclopyr. Thus, these reductions in exposure and/or concentration would benefit selectivity for non-target species when targeting milfoil or other species with a similar use pattern.

As proven, this combination effectively controls milfoil and also could include control curlyleaf pondweed simultaneously; triclopyr being the primary causal agent on milfoil by, albeit not solely, reducing the exposure time of fluridone, or acting as a synergist or additive with fluridone; fluridone being the primary causal agent on curlyleaf pondweed; in combination used at lower effective concentrations than when these species are targeted with triclopyr or fluridone singularly, resulting in improved selectivity to non-target species.

### Example 3

### Control of Eurasian Watermilfoil With Various Combinations Including Triclopyr or 2,4-d

### Materials and Methods

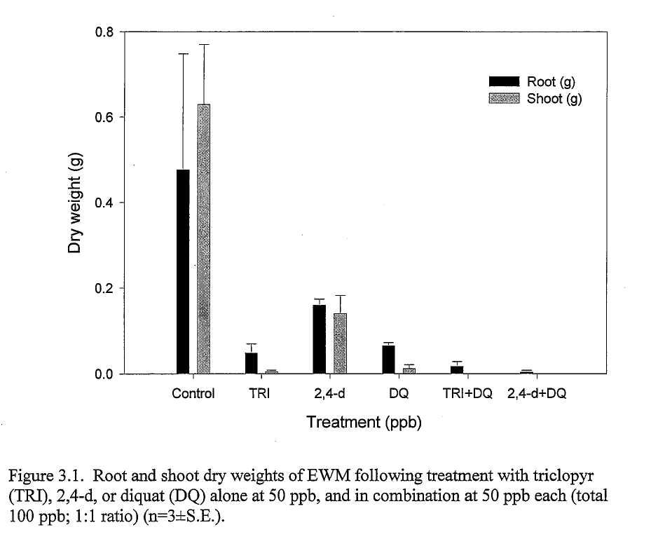

Apical sections (12 to 15 cm in length) of Eurasian watermilfoil (EWM) were planted into small pots (13.5 cm length×3.75 cm diameter) containing Wallace Farm® (topsoil amended with 14-14-14 slow release Osmocote® fertilizer (˜2.5 g Osmocote/kg soil). Approximately 5 to 7 cm of the apical section extended above the sediment at planting, and a sand cap was placed over the potting soil (˜2 cm deep). Plants were then transferred to a 12 L acrylic tanks filled with well water. Plants were allowed to grow to two-thirds the height of tanks (approximately 7 d) before the following treatment was initiated in triple replicate: 1) Untreated controls, 2) triclopyr 50 ppb, 3) 2,4-d 50 ppb, 4) diquat 50 ppb, 5) diquat 50 ppb+triclopyr 50 ppb, 6) diquat 50 ppb+2,4-d 50 ppb. Plants were harvested at 32 d. At harvest, plants were rinsed free of algae, roots and shoots were separated, and placed in paper sacks in a drying oven for 4 d at 70° C. temperature, and dry weights were determined (FIG. 3.1).

### Results

The results of this experimental are summarized in FIG. 3.1. As shown, the combinations tested proved to be compatible and demonstrated the ability to control the watermilfoil. As in Example 2, root and shoot biomass was separated to evaluate potential for regrowth following herbicide exposure. It is notable that diquat is a contact herbicide that controls above ground portions of plants under field conditions; regrowth thus occurs from root-stock or root tissue. Although diquat (50 ppb) caused a 86% reduction in root biomass in this study, greater effects were observed when applied in combination with triclopyr or 2,4-d. Combinations of 2,4-d (50 ppb) or triclopyr (50 ppb) with diquat (50 ppb) resulted in 96 to 99% control of root mass compared to untreated controls. 2,4-d alone at these rates caused a 66% reduction; triclopyr a 90% reduction. It was not anticipated that a combination of diquat and triclopyr or 2,4-d would increase efficacy, but increased efficacy was observed in this experimental. There is potential for antagonism between these herbicides: diquat requires shorter exposure than triclopyr/2,4-d; diquat is a contact herbicide whereas triclopyr/2,4-d are systemic. Diquat injures susceptible plants very quickly with resultant loss in cell integrity, which could inhibit or preclude effective translocation of a systemic herbicide such as triclopyr or 2,4-d. However, antagonistic activity was not observed in this experimental, demonstrating that the agents can be effectively used together without suffering antagonism.

### Example 4

### Use of 2,4-d and Triclopyr Combinations for Submersed Weed Control

### Materials and Methods

Eurasian watermilfoil (EWM) was collected from ponds in Seymour, Ind. Single apical meristems were planted into small pots (13.5 cm length×3.75 cm diameter) containing Wallace Farm® (topsoil amended with 14-14-14 slow release Osmocote® fertilizer (˜2.5 g Osmocote/kg soil). Approximately 5 to 7 cm of the apical section extended above the sediment at planting, and a sand cap was placed over the potting soil (˜2 cm deep). Plants were then transferred to a 12 L acrylic tanks filled with well water. Tanks were maintained in a growth room with 14:10 h photoperiod at 26° C. Plants were allowed to establish growth for 26 days before they were treated.

Pretreatment above ground biomass was harvested the day of the treatment and dry weights were determined. Treatments were replicated three times in a completely randomized design. Treatments included: untreated controls, and 30, 60, 90 and 120 ppb of each of the following: Renovate 3 (T=triclopyr amine liquid, 3# a.e. per gallon), DMA 4 (D=2,4-d amine liquid; 3.8 # a.e. per gallon), T+D 1:1 ratio, T+D 1:1.5, ratio, T+D 1:2.3 ratio, and T+D 1:4 ratio.

All above ground biomass was harvested 33 days after treatment. Biomass was dried to constant moisture at 70° C. for 3 d, and dry weights were determined. Data were subjected to regression analysis using Sigma Plot software, and a GR₅₀ was determined (concentration causing a 50% reduction in dry weight) for each treatment. All data were analyzed for synergism/antagonism using the Isobole analysis at the 95% confidence level (estimated using linear interpolation from 95% confidence bands) (Berenbaum, M. C. 1989, Pharmacological Reviews. 41:93-141; Streibig, J. C. 2003, Assessment of herbicide effects: http://www.ewrs.org/et/inages/, Herbicide interaction.pdf). This model is considered effective for determining synergism/antagonism without making the assumption that herbicides act independently when applied in combination (Green, J. M. and J. C. Streibig, 1993, Herbicide mixtures, Pages 117-134 in J. C. Streibig and P. Kudsk, eds. Herbicide Bioassays. Boca Raton, Fla.: CRC). The method assumes the efficacy of herbicides in combination is equal to efficacy of the individual compounds unless there is synergism or antagonism (Armel, G. R., P. L. Rardon, M. C., McComrick and N. M. Ferry, 2007, Weed Tech., 21:947-953).

### Results

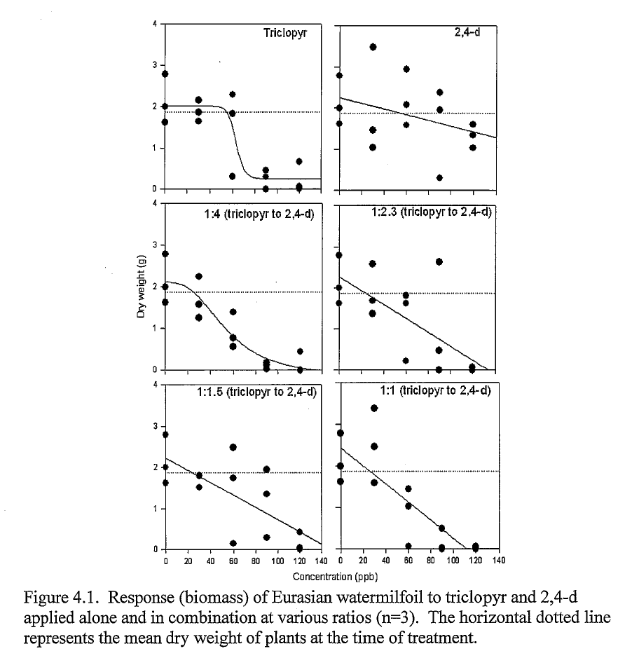

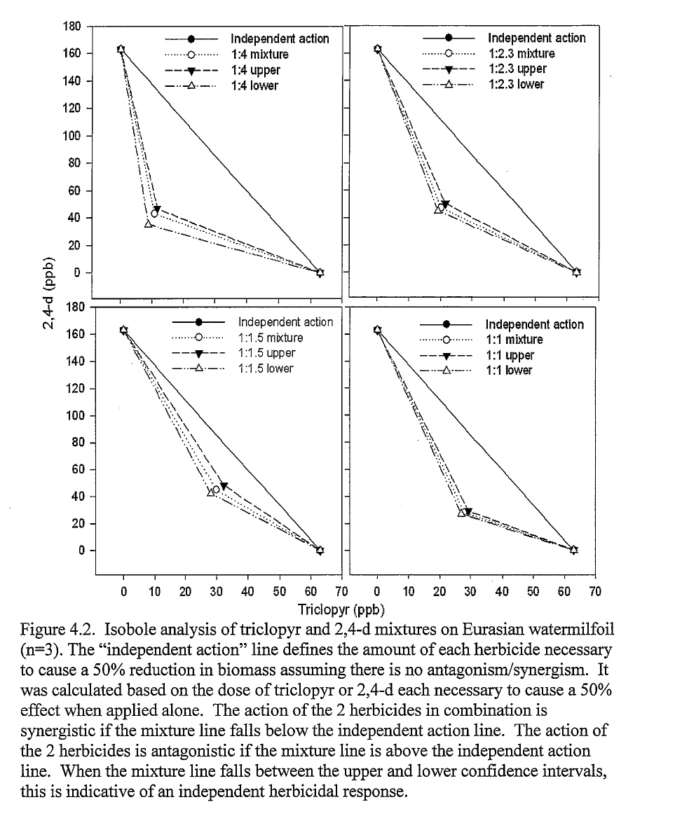

Data were subjected to linear regression to calculate GR₅₀ values, with the exception of triclopyr and triclopyr+2,4-d 1:4 ratio, which were subjected to a 4 parameter standard curve analysis for better fit (FIG. 4.1). The GR₅₀ for 2,4-d alone was 162.6 ppb and triclopyr alone was 63.0 ppb. The GR₅₀ for all ratios of triclopyr and 2,4-d combinations ranged from 54.0 to 74.7 ppb, which was similar to triclopyr alone. However, in these ratios, triclopyr contributed a small percentage of the total concentration. For example, at a 1:4 ratio the GR₅₀ was 54.0 ppb; the triclopyr component would be 10.8 ppb and the 2,4-d component 43.2 ppb. These concentrations represent values significantly lower than the individual GR₅₀ values for either herbicide. At a 1:2.3 ratio, the GR₅₀ is 67.1 ppb, with the triclopyr contribution being 20.1 ppb and the 2,4-d contribution being 47.0 ppb.

All ratios of triclopyr to 2,4-d tested resulted in an unexpected synergistic effect based on the Isobole analysis (FIG. 4.2). The 2,4-d concentration required to elicit a synergistic effect with triclopyr was lowest in the 50:50 mixture (28.05 ppb), but ranged from 43.2 to 46.97 for all other ratios. The triclopyr concentrations required in mixture was the lowest at the 1:4 ratio at 10.8 ppb, but ranged from 20.13 to 29.88 for all other ratios. The concentration of triclopyr and 2,4-d that resulted in a synergistic effect averaged across all ratios was 40.8 ppb 2,4-d and 22.2 ppb triclopyr (1.84:1 ratio), which possibly could represent the ideal ratio to maximize the synergistic effect between triclopyr and 2,4-d. One interesting thing to note is the increasing triclopyr concentration necessary to cause a synergistic response with decreasing ratios (Table 4.1). The triclopyr concentrations increases in the 1:4, 1:2.3 and 1:1.5 ratio from 11 to 20 to 30 respectively, whereas the 2,4-d requirement stays relatively similar (43, 47, and 45 ppb). This suggest, in addition to the GR₅₀ 95% confidence intervals, that the ideal combination would be a 1:4 triclopyr to 2,4-d ratio The optimum ratio probably falls between 1:1.8 to 1:4 ratio. Nonetheless, all combinations of triclopyr and 2,4-d exhibited a synergistic effect on the submersed plant tested.

TABLE 4.1
Calculated GR₅₀ values (ppb) for triclopyr and 2,4-d applied alone
and at various ratios in combination to Eurasian watermilfoil.

| | GR₅₀ | | Triclopyr ppb: | |
|---|---|---|---|---|
| Herbicide | (ppb) | 95% C.I. | 2,4-d ppb (GR₅₀) | Regression |
| 2,4-d amine | 162.6 | 115 to n.a. | n/a | linear |
| Triclopyr amine | 63.0 | 46 to 88 | n/a | 4 parameter |
| 1:4 ticlopyr:2,4-d | 54.0 | 44 to 58 | 11:43 | 4 parameter |
| 1:2.3 triclopyr:2,4-d | 67.1 | 64 to 72 | 20:47 | linear |
| 1:1.5 triclopyr:2,4-d | 74.7 | 71 to 81 | 30:45 | linear |
| 1:1 triclopyr:2,4-d | 56.1 | 54 to 59 | 28:28 | linear |

Variance was estimated using linear interpolation from 95% confidence intervals (n = 3). The “triclopyr ppb:2,4-d ppb” was calculated by multiplying the GR₅₀ value times the individual ratio for each herbicide.

The uses of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. In addition, all references cited herein are indicative of the level of skill in the art and are hereby incorporated by reference in their entirety.

1. A method for controlling aquatic weeds in a body of water, comprising:
providing in the body of water an herbicidal combination including:
a first herbicidal agent selected from triclopyr and 2,4-d; and
a second herbicidal agent selected from fluridone, diquat, an ALS inhibitor, or 2,4-d;
with the proviso that when the second herbicidal agent is 2,4-d the first herbicidal agent is triclopyr,
so as to control the aquatic weeds.

2. The method of claim 1, wherein the aquatic weeds include watermilfoil.

3. The method of claim 1, wherein the first herbicidal agent is triclopyr.

4. The method of claim 3, wherein said second herbicidal agent is fluridone.

5. The method of claim 3, wherein said second herbicidal agent is diquat.

6. The method of claim 3, wherein said second herbicidal agent is an ALS inhibitor.

7. The method of claim 6, wherein said ALS inhibitor includes at least one member selected from the group consisting of penoxsulam, bensulfuron-ethyl, bispyribac-sodium, and imazamox.

8. The method of claim 3, wherein said second herbicidal agent is 2,4-d.

9. The method of claim 1, wherein said first herbicidal agent is 2,4-d.

10. The method of claim 9, wherein said second herbicidal agent is fluridone.

11. The method of claim 9, wherein said second herbicidal agent is diquat.

12. The method of claim 9, wherein said second herbicidal agent is an ALS inhibitor.

13. The method of claim 12, wherein said ALS inhibitor includes at least one member selected from the group consisting of penoxsulam, bensulfiron-ethyl, bispyribac-sodium, and imazamox.

14. An herbicidal composition, comprising an herbicidal combination including:
a first herbicidal agent selected from triclopyr and 2,4-d; and
a second herbicidal agent selected from fluridone, diquat, an ALS inhibitor, or 2,4-d;
with the proviso that when the second herbicidal agent is 2,4-d the first herbicidal agent is triclopyr.

15. The composition of claim 14, wherein the first herbicidal agent is triclopyr.

16. The composition of claim 15, wherein said second herbicidal agent is fluridone.

17. The composition of claim 15, wherein said second herbicidal agent is diquat.

18. The composition of claim 15, wherein said second herbicidal agent is an ALS inhibitor.

19. The composition of claim 18, wherein said ALS inhibitor includes at least one member selected from the group consisting of penoxsulam, bensulfuron-ethyl, bispyribac-sodium, and imazamox.

20. The composition of claim 15, wherein said second herbicidal agent is 2,4-d.

21. The composition of claim 14, wherein said first herbicidal agent is 2,4-d.

22. The composition of claim 21, wherein said second herbicidal agent is fluridone.

23. The composition of claim 21, wherein said second herbicidal agent is diquat.

24. The composition of claim 21, wherein said second herbicidal agent is an ALS inhibitor.

25. The composition of claim 24, wherein said ALS inhibitor includes at least one member selected from the group consisting of penoxsulam, bensulfuron-ethyl, bispyribac-sodium, and imazamox.

26. A multi-pack herbicide product, comprising:
a first container containing triclopyr or 2,4-d;
a second container containing at least one member selected from the group consisting fluridone, diquat, an ALS inhibitor, or 2,4-d;
with the proviso that when the second container contains 2,4-d, the first container contains triclopyr; and
a package holding said first container and second container.
